(19) United States
(12) Patent Application Publication
(10) Pub. No.: US 2006/0224480 A1
(43) Pub. Date: Oct. 5, 2006

(54) Systems and methods for loan management with variable security arrangements

(75) Inventors: Bruce Bent, New York, NY (US); Bruce Bent II, New York, NY (US); Mark Vernaglia, Colts Neck, NJ (US)

Correspondence Address: FOLEY AND LARDNER LLP;SUITE 500, 3000 K STREET NW, WASHINGTON, DC, 20007, US

(73) Assignee: Reserve Solutions, Inc.

(21) Appl. No.: 11/092,598

(22) Filed: Mar. 29, 2005

(51) Int. Cl. G06Q 40/00

(52) U.S. Cl. 705/35

(57) ABSTRACT

A data processing system, program product, and method is provided for managing at least one credit-granting account of a participant. The system comprises in one embodiment an electronic database including information describing collateral assets of the participant used for securing the credit-granting account, and a computer system comprising one or more processors coupled to the electronic database and programmed among them to establish through an API a credit-granting account with a facility to maintain a plurality of collateral assets as collateral for the credit-granting account; receive new information regarding a collateral asset that is real estate for securing the credit-granting account; determine perfection status of a security interest in the collateral asset; store, in the electronic database, the new information and at least any change in the perfection status; and determine an interest rate to be charged on outstanding credit balances based on the new information regarding the collateral asset available for securing the credit-granting account containing the perfection status. The system further comprises an electronic network access device for sending a signal identifying the new interest rate to an access-vehicle issuing system so that the issuing system can charge the interest rate on outstanding credit balances. In one of the alternative embodiments, the system sends a signal identifying the interest rate to an interest rate program that controls the interest rate for the credit-granting account.

### BACKGROUND OF THE INVENTION

Changes in United States tax codes have eliminated the tax deductibility of conventional consumer debt. This has dramatically increased the cost of funds for consumers. For example, conventional bank credit card borrowing currently carries high interest rates, usually 1.5% per month or up to 20% or more on an annualized basis, and offers no tax advantages at the present.

Home equity loans are loans secured by the equity in the borrower's real estate. In contrast to conventional consumer debt, the interest paid on such home equity loans is often tax deductible in the United States. Home equity remains a largely untapped reservoir of inexpensive capital for many individuals. Often, the largest or in some case, the only, pool of capital and savings for low and moderate income consumers, is from the beneficial interests and equity they have built in their homes.

Residential equity secured financing has the benefit of tax deductibility of the interest accrued as opposed to most current forms of consumer credit financing. Such loans provide consumers the advantage of a resource pool of funds with a tax deductible interest. From the lender's perspective, equity secured financing is less costly since the default rate on such loans is much less than the default rates for traditional or unsecured credit card financing. Lenders are therefore able to offer lower interest rates and finance charges on such types of loans. However, such home equity loans are almost never used for small loans.

### SUMMARY OF THE INVENTION

In one embodiment, the present invention provides a method, program product and system for managing at least one credit-granting account of a participant.

In one embodiment, a data processing system is provided for managing at least one credit-granting account of a participant, said system comprising: an electronic database including information describing collateral assets of the participant used for securing the credit-granting account, and a computer system comprising one or more processors coupled to the electronic database and programmed among them to establish through an API a credit-granting account with a facility to maintain a plurality of collateral assets as collateral for the credit-granting account; receive new information regarding a collateral asset that is real estate for securing the credit-granting account; determine perfection status of a security interest in the collateral asset; store, in the electronic database, the new information and at least any change in the perfection status; determine an interest rate to be charged on outstanding credit balances based on the new information regarding the collateral asset available for securing the credit-granting account containing the perfection status; and an electronic network access device for sending a signal identifying the new interest rate to an access-vehicle issuing system so that the issuing system can charge the interest rate on outstanding credit balances.

In a further embodiment, a program product is provided for managing at least one credit-granting account of a participant, comprising a set of computer readable media having machine-readable program code embodied among them, that when executed by one or more machines, are capable of performing the following method steps, where set is one or more: establishing through an API a credit-granting account with a facility to reference one or more collateral assets as collateral for the credit-granting account; receiving new information regarding a collateral asset that is real estate for securing the credit-granting account; determining a perfection status of a security interest in the collateral asset; storing the new information in the electronic database and at least any change in the perfection status; determining an interest rate to be charged on outstanding credit balances based on the new information regarding the collateral asset available for securing the credit-granting account containing the perfection status; and sending a signal identifying the interest rate to an access-vehicle issuing system so that the issuing system can now charge the interest rate.

In a yet further embodiment, a method is provided for managing at least one credit-granting account of a participant, said method comprising: establishing through an API a credit-granting account with a facility to at least one collateral asset as collateral for the credit-granting account; receiving new information regarding a collateral asset that is real estate for securing the credit-granting account; determining a perfection status of a security interest in the collateral asset; storing, in a electronic database, the new information and at least any change in the perfection status; determining electronically an interest rate to be charged on outstanding credit balances based on the new information regarding the collateral asset available for securing the credit-granting account containing the perfection status; and sending a signal identifying the interest rate to an interest rate program that controls the interest rate for the credit-granting account.

In a yet further embodiment, a method is provided for managing at least one credit-granting account of a participant, said method comprising: receiving information from the participant regarding a real estate collateral asset for securing the credit-granting account, storing, in an electronic database, the received information, determining a new interest rate to be charged on outstanding account credit balances based on information regarding the collateral assets available for securing the credit-granting account, and sending a signal identifying the interest rate to an interest rate program that controls the interest rate for the credit-granting account.

In a yet further embodiment, a data processing system is provided for managing at least one credit-granting account of an participant, said system comprising: an electronic database containing information describing collateral assets used for securing the credit-granting account, and a computer system comprising one or more processors coupled to the electronic database and programmed to receive information from the participant regarding a real estate collateral asset for securing the credit-granting account, store, in the electronic database, the received information, determine a new interest rate to be charged on outstanding credit balances based on information regarding the collateral assets available for securing the credit-granting account, and communicate the interest rate to an interest rate program that controls the interest rate for the credit-granting account.

In a yet further embodiment, a program product is provided for managing at least one credit-granting account of a participant, comprising a set of computer readable media having machine-readable program code embodied among them, that when executed by one or more machines, are capable of performing the following method steps, where set is one or more: receiving information from the participant regarding a real estate collateral asset for securing the credit-granting account, storing in an electronic database, the received information, determine a new interest rate to be charged on outstanding credit balances based on information regarding the collateral assets available for securing the credit-granting account, and sending a signal identifying the interest rate to an interest rate program that controls the interest rate for the credit-granting account.

### BRIEF DESCRIPTION OF THE DRAWINGS

The present invention is illustrated by way of example, and not by way of limitation, in the figures of the accompanying drawings and in which like reference numerals refer to similar elements in which:

FIG. 1 illustrates a number of parties and components in one embodiment of the method and system of the present invention;

FIG. 2 illustrates one embodiment of a system and data flow consistent with the invention;

FIG. 3 and 4 illustrate exemplary embodiments of methods of application processing under the invention;

FIGS. 5A-C illustrate embodiments of update methods for account security status and interest rate in accordance with exemplary embodiments of the invention; and

FIG. 6 illustrates a method in accordance with an exemplary embodiment.

### DETAILED DESCRIPTION OF THE PREFERRED EMBODIMENTS

The inventors have recognized that lenders of home equity loans require a significant amount of documentation from borrower regarding the real estate property securing the loan and regarding the borrower's credit history. The efforts required by both parties to produce, collect and maintain such information results in home equity loans not being worthwhile unless the amount borrowed exceeds a certain threshold, usually $25,000 to $50,000.

The inventors have also recognized that it has been inconvenient and impractical for many consumers to borrow easily against the equity of the home where the line of credit or loan was for less than a threshold amount. Indeed, from the lender's perspective, the amount of work required for granting small home equity loans and the associated administrative costs are not significantly less than the work and costs associated with larger loans, while the profit margin was significantly less. Accordingly, such smaller amount loans secured by home equity were not offered to consumers or were offered on less than reasonable terms.

The inventors have also recognized that from the consumer's perspective, traditional home equity loans have been implemented in a manner that is time consuming, paper intensive, and cumbersome. Especially burdensome have been application processes, accessing available home equity, setting the size of the credit line, and establishing and discharging the security instrument (first or second mortgage). Accordingly, consumers often avoid obtaining and using home-equity-secured credit for day-to-day transactions or for small loan amounts. Instead, consumers, and particularly those of low and moderate income levels, avoid equity financing and instead rely on high interest rate credit cards for their financing needs.

The inventors have recognized that there is a largely unserved market. Consumer's with access to home equity and a need for a relatively small loan or line of credit, either for home improvement projects, consolidating credit card debts, or other purposes, cannot easily make use of the equity in their homes to secure financing. Lenders are unwilling or unable to offer home equity based financing for small amounts due to the administrative costs.

The systems and methods of the present invention permit secured consumer financing that in selected embodiments may be streamlined and/or convenient, and/or cost effective, especially financing secured by consumer home equity. With selected embodiments of the present invention, consumers will benefit by receiving financing with lower interest rates. With selected embodiments of the present invention, lenders will benefit from reduced default rates on such loans and from the consequent lower administrative and default costs. Thus, by means of this invention, consumers will now be afforded one or more of low cost and easily obtainable financing.

In the embodiments of the systems and methods of the present invention that are described herein, the following terms are used:

(1) a “line of credit” (LOC) amount for an account or loan arrangement is the maximum amount of credit that an issuing financial institution will extend on the account or arrangement; an “available LOC” amount is an unused amount of the account's LOC;

(2) an “account” or a “loan arrangement” grants credit with variable security arrangements as are managed by the systems and methods of the present invention;

(3) a “participant” is a user of an account or loan arrangement of the present invention; generally, a participant is any natural or legal person that uses payment vehicles to make purchases or other transactions; often the participant will be a natural person making purchases (a “consumer”); a person participating in the application process is known as an “applicant”;

(4) a “payment vehicle” is a means of making payment such as ACH transfers, checks, credit or debit cards, for example;

(5) “collateral” is any asset pledged by a borrower to secure a loan or other credit, and subject to seizure in the event of default;

(6) “security interest” refers to the right of a creditor to take all or part of an asset offered as collateral;

(7) “perfect” is the process involving the elimination of any adverse claims against a title;

(8) Other related terms have such meanings as are normal in real estate and commercial practice;

(9) “API”—An application programming interface (API) is one or more programmatic methods provided by a system of some kind (an example is a web-based imaging system) that enables client programs (web content operating within the browser is one example) to interact with that system. One method of creating an API is to create a library. For example, in Java, a library (conventionally called ajar file) is created by defining a class or classes, compiling the class or classes, and grouping the class or classes into a library.

Embodiments within the scope of the present invention include program products comprising computer-readable media for carrying or having computer-executable instructions or data structures stored thereon. Such computer-readable media can be any available media that can be accessed by a general purpose or special purpose computer. By way of example, such computer-readable media can comprise RAM, ROM, EPROM, EEPROM, CD-ROM or other optical disk storage, magnetic disk storage or other magnetic storage devices, or any other medium which can be used to carry or store desired program code in the form of computer-executable instructions or data structures and which can be accessed by a general purpose or special purpose computer. When information is transferred or provided over a network or another communications connection (either hardwired, wireless, or a combination of hardwired or wireless) to a computer, the computer properly views the connection as a computer-readable medium. Thus, any such connection is properly termed a computer-readable medium. Combinations of the above are also to be included within the scope of computer-readable media. Computer-executable instructions comprise, for example, instructions and data which cause a general purpose computer, special purpose computer, or special purpose processing device to perform a certain function or group of functions.

The invention is described in the general context of method steps, which may be implemented in one embodiment by a program product that comprise computer-executable instructions, such as program code, executed by computers in networked environments. Generally, program products include routines, programs, objects, components, data structures, etc. that perform particular tasks or implement particular abstract data types. Computer-executable instructions, associated data structures, and program modules represent examples of program code for executing steps of the methods disclosed herein. The particular sequence of such executable instructions or associated data structures represents examples of corresponding acts for implementing the functions described in such steps.

The present invention in some embodiments, may be operated in a networked environment using logical connections to one or more remote computers having processors. Logical connections may include a local area network (LAN) and a wide area network (WAN) that are presented here by way of example and not limitation. Such networking environments are commonplace in office-wide or enterprise-wide computer networks, intranets and the Internet. Those skilled in the art will appreciate that such network computing environments will typically encompass many types of computer system configurations, including personal computers, hand-held devices, multi-processor systems, microprocessor-based or programmable consumer electronics, network PCs, minicomputers, mainframe computers, and the like. The invention may also be practiced in distributed computing environments where tasks are performed by local and remote processing devices that are linked (either by hardwired links, wireless links, or by a combination of hardwired or wireless links) through a communications network. In a distributed computing environment, program modules may be located in both local and remote memory storage devices. Furthermore, databases described herein as part of the present invention may be stand-alone databases or distributed database systems comprising a plurality of databases connected to or accessible by a common processor.

Software and web implementations of the present invention may be accomplished with programming techniques with rule based logic and other logic to accomplish the various database searching steps, correlation steps, comparison steps and decision steps. It should also be noted that the word “component” as used herein and in the claims is intended to encompass implementations using one or more lines of software code, and/or hardware implementations, and/or equipment for receiving manual inputs.

Embodiments of the present invention include data processing systems that are programmed to access or store credit histories of applicants and participants, and to store evidence including image data for perfected security interests (such as, security documents, e.g., mortgages) as part of establishing and administering credit accounts with determined LOC amounts for participants to use in credit based transactions. The data processing systems may be programmed to establish and administer a plurality of credit accounts for a plurality of participants. In one embodiment, for each participant account, the systems determine an LOC amount from the participant's credit criteria and credit history according to credit models or rules established by issuing financial institutions (such as, banks, credit unions, etc.). In a further embodiment, the value of any security, its class, and the status of other liens against the security may also be considered in setting the LOC amount. The systems monitor and determine financing criteria (e.g., interest rates) for each plan participant account depending on the determined LOC and on collateral the participant has made available to secure the account. The systems are further programmed to interface to appropriate programs in other financial systems, in one embodiment in a manner similar to the existing Mastercard/VISA settlement network, so that the LOC amount may be accessed by a wide variety of payment vehicles (check, credit card, debit card, wire transfer, ACH, sweeps, etc.) for use in participant loans, consumer transactions, cash advances, and the like. Such systems and networks are known to those skilled in the art.

The participant may make available a wide range of collateral including, for example, real property such as a personal or vacation residence. Personal property such as an automobile or jewelry, intangible property such as interests in financial securities, etc. may be added to the real property collateral. The invention includes situations in which a third party may make property available to secure the participant's account. In one embodiment, property to be used as security in the present invention belongs freely to an owner (in which the owner holds title), usually the participant, so that the owner may grant security interests. Therefore, some embodiments of the present invention exclude arrangements of the nature of repurchase (repos) arrangements where credit is secured by a temporary transfer of securities or other property or the use of leased property in which the participant does not hold title. Also in some embodiments, the present invention excludes such well known arrangements such a “set-off” type agreement between a credit-granting account and other deposit, savings, or investment accounts (or the like) at the same institution. According to such agreements, a default in the credit-granting account may be satisfied out of the set-off account.

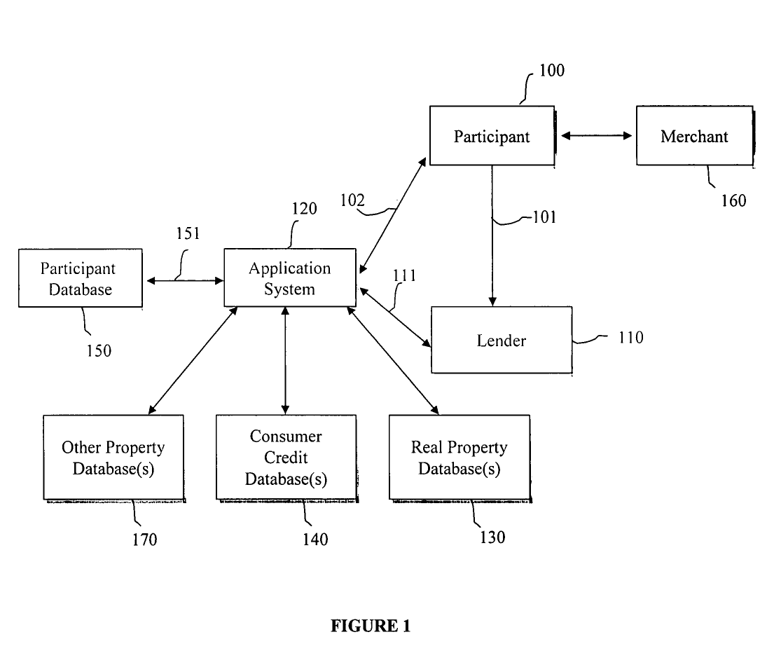

FIG. 1 illustrates one embodiment of the method and system of the present invention and shows the relationships between the various parties and components. In this illustration, a “participant” is shown in box 100. It is this participant who wishes to obtain a loan or line of credit from a lender, shown in box 110. Application for such credit may be made electronically via a computer used by the participant that connects to a lender computer system on line 101 via an electronic network such as the Internet, or may be made manually. The lender computer system may then redirect such communication on line 101 to a Reserve application system as shown in box 120. The application system 120, in one embodiment, may be implemented on a computer server and connects to the lender system via an electronic network such as the Internet. In an alternative embodiment, the participant 100 connects directly to the application system 120 on line 102 and accesses a credit granting application program specifically tailored to potential customers of the lender 110. Whether connected directly or indirectly, the application system, 120 provides the participant 100 with an application programming interface (API) through which the consumer can access the relevant credit granting application program.

The application system 120 is in turn connected to various databases that may be distributed databases. These databases include third party real property databases 130 and third party consumer credit databases 140 and other property databases 170. Real property databases include information regarding real property that may be used as collateral for a loan or line of credit. Such information may include, for example, public assessment records, title histories, liens and other security interest perfection information. Other property databases 170 include information regarding personal property and other “non-real” property which may be used to secure a loan or line of credit and security interest perfection information therefore. Consumer credit databases 140 include credit information regarding the specific consumer or participant applying for a loan or line of credit. The use of these databases is explained in greater detail herein.

The application system 120 is also connected to a participant database 150 which may comprise one database or a set of distributed databases. This database 150 is coupled to a processor in the application system 120 via a direct connection via line 151 or through an electronic network such as the Internet. The database 150 includes information describing collateral assets of the participant that will be used to secure the credit grant account for which the participant has applied. It can also be used to store information regarding the participant, as well as the perfection status of a security interest in collateral.

As mentioned above, the application system 120 provides a mechanism for the participant 100 either directly or through the lender 110, to establish a new credit granting account. The application system 120 provides a facility to maintain a plurality of collateral assets for that credit granting account. It receives new information from a participant or from other sources regarding a collateral asset that is used to secure the account, and which may include information to determine the perfection status of that asset. Any new information is stored in the database 150. The application system 120 also calculates an interest rate to be charged on outstanding credit balances for current or future (if this is an application for a credit-granting account)the credit granting account based on existing and revised information regarding the collateral assets available for securing the account that may include the perfection status. In one embodiment of the invention, through a network access device appropriate for the communication link 111 between the system 120 and the lender 110, the system 120 can transmit to the lender 110 the information regarding the interest rate that should be charged to the participant 100 on outstanding credit balances and may also transmit that information via line 102 to the participant 100.

After a credit granting account has been established for the consumer 120, the account may then be used to purchase goods and/or services from any number of businesses, illustrated in FIG. 1 as merchant 160. In one embodiment, the party maintaining and operating the application system 120 enters into contractual agreements with the lender 110 to provide the services described above. The application system 120 operation party, or any other convenient party, may also contract with the purveyors of electronic information contained in the databases 140 and 130 for access and, in one embodiment, for the transmission of alerts when predetermined changes occur in the respective databases. The lender 110 and the participant 100 of course also have contractual relationships regarding the provision of a loan or line of credit and repayment obligations regarding the same, e.g., the credit granting account. The merchant 160 may also have a relationship with the participant 100 and also with an electronic funds transfer network (not shown) for clearing the transaction.

As is discussed herein in greater detail, in one embodiment of the present invention, a lender bank can provide an additional product to their customers. The ability to offer this product can be marketed to lender banks, such as community banks and credit unions, as a way to compete with larger banks. Using the present invention, the lender can provide its customers with, in one embodiment, a credit card that is tied to a home equity line of credit and that has a much lower interest rate than a traditional unsecured credit card. In addition, the interest paid on outstanding balances can be tax deductible. Furthermore, it can cost very little for a lender to implement the product. In an exemplary embodiment of the invention, such a credit card is marketed to the consumer using the benefits described above and, in addition, with an introductory interest annual percentage rate of, for example, 10% percent for the first 90 days of use.

Another benefit that can be advocated to the customer is the ability in some embodiments of the invention to be approved for such a credit card substantially in real-time. In one embodiment, an interested consumer may complete relevant information online using a computer connected to the application system 120 either directly or indirectly through the lender 110. The consumer or other participant 100, on his computer, is provided with an application program interface (API) that solicits the information needed by the system.

After the relevant consumer information has been collected and submitted to the application system 120, the consumer's credit may be verified using third party databases as shown in box 140. In addition, real estate information collected from the consumer can be verified using third party real estate databases as shown in box 130. This verification includes a determination of what other security interests, if any, have been attached to such real estate that is being offered to secure the loan or line of credit. A determination by the system of approval or denial of a credit granting account may be made almost instantaneously. Such credit-granting account approval or denial may be accomplished in one embodiment automatically via a rule-based computer program.

Upon approval, the consumer may be automatically mailed a new account holder packet. This packet includes a credit card which the consumer may then activate using standard security protocols. The packet would also contain a security instrument to be executed by the consumer. The consumer then executes and sends back the security instrument to either the party providing the application system 120 or to the lender 110. The security instrument is then filed with the appropriate local real estate records location required to perfect real estate security interests. At this point, the credit granting account has become secured and the interest paid on any outstanding balances would have tax deductible status. If the security instrument has not been received within a predetermined period of time, such as the introductory 90 day period, the application system 120 changes the interest rate from, for example, 10% to 19%. This information is transmitted to the lender bank. In essence, the credit card becomes an unsecured credit card. Alternatively, the system may set the initial interest rate to 19%, but the system then may drop the interest rate to a lower level, such as 10%, when the signed security instrument is received or when it is recorded. Note that in localities where electronic signature is authorized, such signed security instrument receipt can be transmitted electronically, and/or an appropriate image of the security instrument transmitted, to the application system 120 (if the application is being made remotely), and to the security interest perfection electronic database, and this transmission could even be performed during the application process.

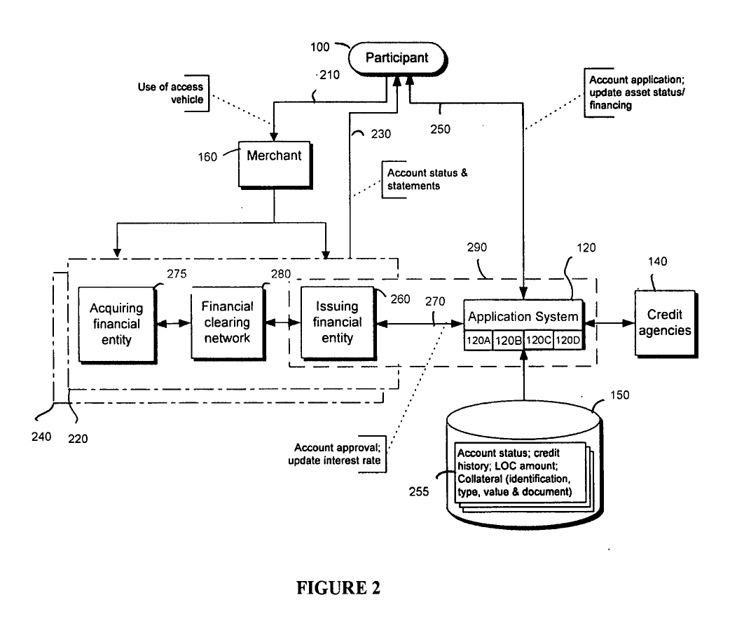

Referring now to FIG. 2, a more detailed embodiment of the invention is shown. As illustrated therein, participant 100 makes credit transaction 210 at merchant 160 using for payment a payment vehicle that may be facilitated, in some embodiments, by the invention. The merchant thus has a credit receivable. Although illustrated as a merchant, these transactions may be with any business entity accepting transactions in payment for goods or services, including cash advances from and other transactions with an issuing financial institution.

In order to satisfy the credit receivables granted, merchant 160 accesses exemplary payment system 220 that services the particular payment vehicle used by participant 100. Payment system 220 is structured in one embodiment to include: an issuing financial entity 260 that issues payment vehicles, opens and maintains participant credit accounts, grants participant credit, settles participant payments, accepts participant credit repayments, etc; an acquiring financial entity 275 (which may be the issuing financial entity) that credits merchant accounts in exchange for credit receivables generated by payment vehicle use; and a financial network 280 that connects issuers with acquirers in order to settle and clear payments between these parties. In one embodiment, each of these entities may be implemented by a mainframe or other computer with an appropriate API. The invention is not limited to conventionally structured payments systems, but instead is adaptable to other types of payment systems that can interface to application system 120 during its subsequently described processing of account applications, collateral updates, and interest rate updates. Also, as illustrated in FIG. 2, the system of the present invention may access multiple payment systems (e.g., 220 and 240).

Application system 120 executes programs implementing the methods of this invention. Generally, these methods accept and process account applications of participants for the credit granting accounts or arrangements of the invention, and also update account status, especially including the status of collateral assets and account interest rate (or other financing charges). System 120 is coupled to data storage device(s) 150 that may be distributed and include participant credit database 255. For each participant with an active loan account or arrangement, database 255 includes an information file structure describing the account. This information in one embodiment includes:
account status—active, secured/unsecured, etc
credit history—past and current;
line of credit (LOC) amount—current and. optionally, available LOC amounts;
collateral status, including for each item, one or more of the following:
   type—real property (e.g., primary residence, vacation home); personal property (e.g., vehicles, jewelry, collectibles), intangible property (e.g., stocks, bonds, intellectual property), etc.
   identification—location, serial number, etc.
   value—market, assessed, etc.
   financing & superior security interests;
   evidence of a binding security interest to the loan account preferably enforceable against third parties—document (e.g., first or second mortgage, financing paper), recordation and perfection information, etc.
   purchase price;
   purchase date;
   original mortgage amount;
   current balance

Most of the participant and account information may be stored in the database 255 in textual or coded forms as known in the art and/or may be included directly or by reference to another database. The evidence of security interests may take any form appropriate to the type of collateral. Images of security documents (e.g., real estate mortgages) may be stored in the database 150, optionally with associated digital authentication to prevent alteration, along with their recordation perfection information. Perfection of a security interest in certain personal or intangible property may require custodial possession, in which case the identity of and access information to this possession are stored. Note that in one embodiment, the perfection information includes the jurisdiction that controls the security interest perfection and requirements for that jurisdiction.

Application system 120 also includes such other computer components as are necessary for its functioning. For example, this system may include one or more processing units operatively coupled to a main memory, communication interfaces and facilities for communication to external systems (including systems of one or more issuing financial entities, one or more payment networks, etc.). Programs for performing the methods of this invention may be introduced into the memories of system 120 from computer readable media, such as disks or tapes, which record these programs in an encoded form, and by network download. In one embodiment, these programs may be written in and translated from a suitable high level language.

Application system 120 may be implemented in different ways. In some embodiments, the application system comprises one or more operating programs that are separate (whether or not co-located) from the systems and programs of the other financial institutions with which it exchanges information, and may be operated by a separate operating entity. The application system may interface, for establishing and managing the accounts of this invention, to more than one issuing financial entity, such as issuing entities of payment systems 220 and 240. Also, the different issuing financial entities may service different types of payment vehicles (including check, credit card, debit card, wire transfer, automated clearing house (ACH), sweep transfers, etc.). Those skilled in the art appreciate that the present invention can be used in connection with any of these or other payment vehicles. The settlement processes for such payment vehicles are well established in the art.

In other embodiments, the issuing financial entity and the operating entity of the application system may be joined in one single entity 290. In such an embodiment, a single computer system or set of computers may be programmed to carry out both issuing entity functions (including account servicing) and application system functions (including interest rate determination). Alternatively, these two embodiments may be combined, and a single entity may also provide application system functions to separate issuing entities, such as an issuing entity of payment system 240.

The methods in accordance with an exemplary embodiment of the present invention, performed by suitable application programs executed by application system 120, generally include: account-application processing 120A, which in cooperation with an issuing financial entity establishes a loan account or arrangement according to this invention; collateral-update processing 120B, which adds or removes items of collateral securing the loan account; interest-rate update processing 120C, which sets a current interest rate on outstanding credit balances; and optional loan-servicing processing 120D.

These processing methods are described herein in one embodiment according to which the different processing functions are invoked and performed in response to the occurrence of external events affecting an account (stochastically). In alternative embodiments, all of these functions may be batched together and performed periodically, for example, daily, or otherwise structured as known in the art.

Account Application Processing

Account application processing 120A may include, in one embodiment, the two sub-functions of initial account approval and initial collateral set-up or update. Preferably, as soon as these sub-functions are completed and a new account receives an active status, the subsequently described interest rate processing is performed.

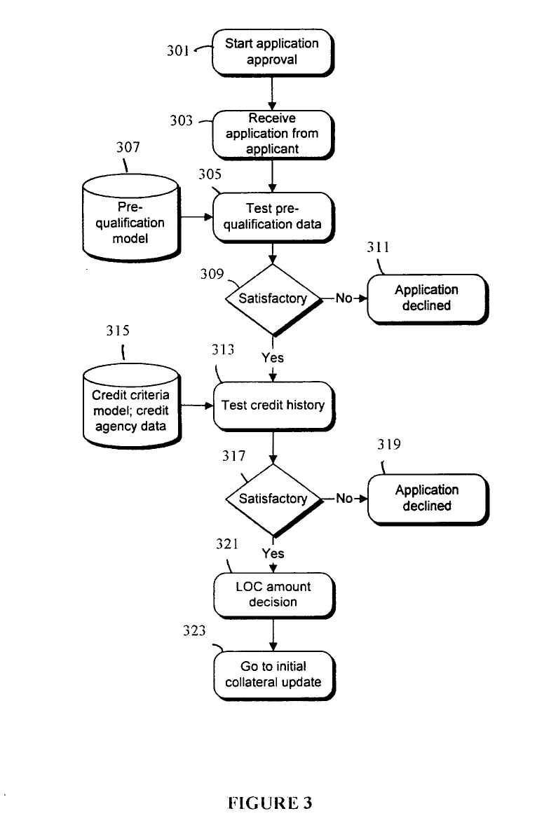

An embodiment of an initial approval and account establishment module is described in FIG. 3. Because this sub-function may be guided by and adapted to the credit analysis and execution policies and practices of the issuing financial institution to which the application system provides account services, FIG. 3 is one embodiment of a credit process in the industry. One of ordinary skill in the art will understand how to adapt this invention to other similar credit processes. The processing for this sub-function commences in operation step 301 upon the receipt in operation step 303 of one or more account applications. Each application is processed through three sequential steps: a pre-qualification test in operation step 305 uses answers provided on a received application to screen account applications and interfaces with a pre-qualification model in operation step 307; a credit history test in operation step 313 uses credit history data from credit agencies (or stored in database 315) and evaluates applications in more detail; and finally an LOC amount decision in operation step 321 determines an approved LOC amount based on this data. If an application fails at the pre-qualification test operation step 305 as determined in operation step 309, it is declined as shown in operation step 311. If an application fails at the credit history operation test 313 as determined in operation step 317, it is declined in operation step 319.

If the application passes both tests, an LOC amount is determined in operation step 321, and it is passed on in operation step 323 for further processing. This three-step process advantageously conserves resources and lowers costs by performing detailed evaluations of only those applications of higher quality according to the pre-qualification.

In more detail, in one embodiment, the pre-qualification test uses the applicant's data provided on a received application as an input to a credit rating/scoring model in order to, for example, obtain an overall credit score or recommendation concerning an applicant's capacity and resources that may be used to accept or decline the application. Typical input data that may be extracted from the received application and applied to the pre-qualification model 307 may include:
Annual gross income;
Debt payments as a percentage of gross income;
Age;
Residence—own, mortgage, state of residence;
Length of time at current residence;
Length of time at current job; etc.

Prequalification model 307 in one embodiment may evaluate this data by using weights derived from statistical analysis of prior credit applications, or by using an expert system based on rules derived from credit-granting experiences, or by using a neural network trained on past credit-granting experiences. Its output may be a yes/no answer, a numerical score, or the like. In one embodiment, a satisfactory decision may be made automatically; for questionable applications, human evaluation may be needed.

For pre-qualified applicants, in one embodiment credit histories may be retrieved from commercial credit rating agencies, as shown in element 315 (such as Equifax, Experian, TransUnion, etc) and input (along with application data) into a further model to perform credit history test in operation step 313. This model may, similarly to the pre-qualification model, be a statistical model, or an expert system, or a neural network, or the like, that also tests an applicant's willingness to pay credit obligations undertaken in the past.

If an applicant passes both these tests, an LOC amount is determined in operation step 321 for a new credit account to be established. The LOC amount in one embodiment, is determined in view of an applicant's ability to repay and focuses on net income available for repayment, that is, on gross income minus taxes, other debt repayments, and the like. For example, the LOC amount may be set to an amount so that repayments (calculated using the default interest rate) would not exceed a pre-determined fraction of net income. In some embodiment the LOC may be made to vary with the currently determined interest rate, for example, being higher for a secured account than for an unsecured account. However, note that if a secured account subsequently becomes unsecured, required payments on an LOC amount set for a secured interest rate may balloon beyond the participants ability to pay when adjusted to a higher unsecured interest rate. In alternative embodiments, the LOC amount may be varied with the collateral value and type.

In alternative embodiments, the pre-qualification and credit history tests may be combined into a single step responsive to a single credit model; further, the LOC amount decision 321 may also be combined into such a single-step. Generally, the invention encompasses modifications to this sub-function that are adapted to those different issuing financial entities with credit policies and practices that approve credit accounts and make LOC amount decisions based on objective application data and credit history data processed according to programmable methods. Indeed, some or all of this processing may be performed by systems of the issuing financial entity.

In another alternative embodiment, the system performs a so-called “stress test” wherein if one or more predetermined criteria are met, the additional credit verification related tests or steps are performed, such as the performance of a new title search or status review perfection databases for one or more of the collateral assets listed for the credit-granting account. Such criteria may include for example the LOC rising above a threshold amount and the credit score of the applicant dropping below a threshold amount.

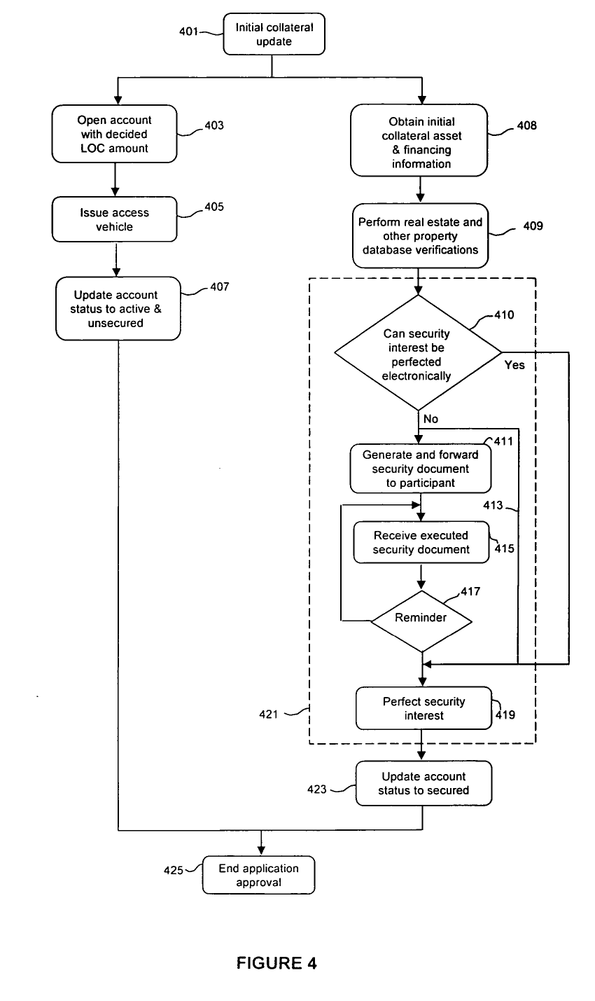

FIG. 4 illustrates the second sub-function of account-application processing, initial collateral set-up or update step 401 (120B in FIG. 2). This sub-function includes two separate components, account setup and initial collateral input, that are illustrated in one embodiment where they are performed in parallel to minimize delays in finishing application processing.

Account setup may also be guided in some embodiments by the policies and practices of the issuing financial entity, and may be adapted to differing issuing entities even to the extent of being performed in whole or in part by issuing financial entity systems. In operation step 403, an account setup opens a credit granting account, such as a revolving credit account or loan arrangement on the books of the issuing financial entity so that (according to the account agreement) the participant, the now approved applicant, is able to use the chosen payment vehicle for advances up to the determined LOC amount, and be notified of repayment obligations. Part of this setup processing sets the initial interest rate to a default, which in some embodiments may be the interest rate for an unsecured account. In other embodiments, there may be different default rates that are triggered/selected based on one or more criteria, such as the amount of the LOC, the participant's credit history, and whether there is a promotion in effect at the time of the application. Then, in operation step 405, the chosen payment vehicle is issued to the participant. For example, a credit card or checks are mailed to the participant. Finally, in operation step 407, the account status is updated to indicate that the account is active but currently unsecured.

The initial collateral input processing component of account application processing is shown in FIG. 4 in operation steps 408-423. If a participant chooses not to provide collateral at the time of account establishment, the initial collateral processing is not performed. The participant is given the option of adding or updating collateral at a later time. If a participant does choose to provide collateral at the time of account establishment, in operation step 408, processing begins with the obtaining of information regarding the asset the participant proposes to use as collateral to secure the credit account or account arrangement. This information may have already been provided on the account application, or may be collected at some later time after account approval. Whenever collected, collateral information may include, in one embodiment, the following:
type—real property (e.g., primary residence, vacation home); personal property (e.g., vehicles, jewelry, collectibles), intangible property (e.g., stocks, bonds, intellectual property), etc
identification—real property location, personal property serial numbers, custodial location of moveable property, etc;
value—current condition, market value, assessed value, purchase price, etc;
superior interests—superior security interests, liens, etc.

Certain of this information may require communication with third-party or governmental computer systems, or may require third party inspection of documents often at government offices. This is illustrated as operation step 409 in FIG. 4. In some embodiments, formal title searches and the like are performed. In other embodiments, formal title searches are performed only if the LOC amount exceeds a threshold. Note that in some embodiments, this searching can be performed entirely electronically via networked access to the appropriate electronic databases. The inquiry and inspection should attempt to prevent a participant from using the same item of collateral more than once as security without providing information concerning superior interests. If, during this determination, a problem is identified with the title or recordation of the collateral, a query is made to the participant before the process is permitted to continue. Where collateral is not of a type that is recorded or is recorded only locally, fraud prevention may involve searching in various locations (for example, files of the secretaries of the various states) for the identified collateral. Note that in some embodiments, this searching can be performed entirely electronically via networked access to the appropriate electronic databases.

The group 421 of next operation steps 410, 411, 413, 415, 417, and 419 function together to create and perfect a new security interest. Group 421 may therefore be considered as a new-security-interest subroutine. If it is determined in operation step 410 that the collateral is of such a type that a security interest to the benefit of the issuing financial entity (which extends credit to the participant) may be legally established and perfected against third parties by electronic means, and that the jurisdiction permits it, then processing proceeds 413 directly to operation step 419, which automatically sends a signal with the necessary data and any required document or other image to the appropriate state or entity system to perfect a security interest in the collateral in a manner appropriate to the type of collateral. Whether a security interest may be perfected electronically will depend on the jurisdiction and the asset class. Otherwise, manually executed documents (such as a second mortgage) are necessary for perfection, and this processing generates and forwards, in operation step 411, an appropriate document to the participant. Processing then waits until the executed document is received, in operation step 415, from the applicant. If necessary, in operation step 417, the applicant is reminded to execute and return the document. Next, the received document is used to perfect the security interest at operation step 419. For example, perfection of an interest in personal and intangible property is generally governed by the state version of the Uniform Commercial Code (UCC), and interests in for real property, generally by the state real property law.

Finally, the account status is updated in operation step 423 to reflect the new or added collateral, and the characteristics of the collateral are recorded in database 150.

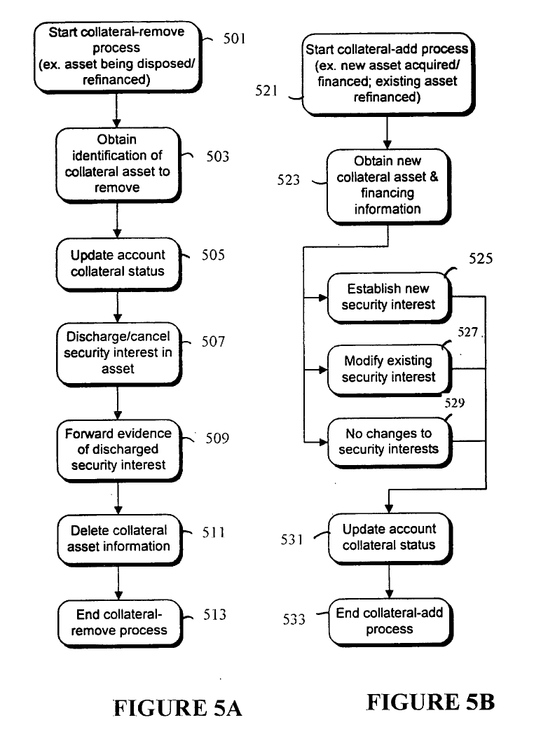

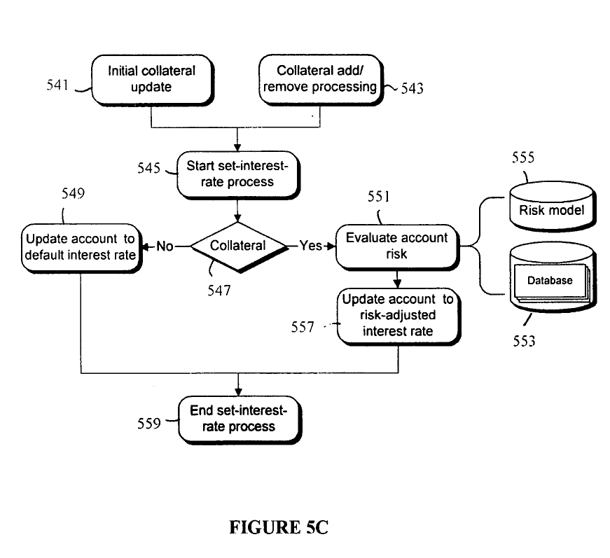

After the completion in operation step 425 of application approval processing, the current account interest rate is updated and the account status is set to reflect current account security status. An interest rate update process is described with respect to FIG. 5C.

Collateral Update Processing

A participant may at any time freely change the collateral status of an active account by adding or removing items of collateral, or by adding, removing, or changing security interests superior to those maintained by this invention. Collateral change processing commences upon the receipt of a collateral change request (request 250 in FIG. 2). FIG. 5A illustrates the processing to remove a collateral asset, and FIG. 5B illustrates collateral add or change processing. After completion of all collateral updates, including initial collateral updates in connection with loan establishment, the current interest rate charged to the participant for outstanding balances is re-evaluated as illustrated in FIG. 5C.

Turning to FIG. 5A, processing to remove a collateral asset commences in operation step 501 by obtaining, in operation step 503, identification of the asset to be removed through interaction (e.g., request 250 in FIG. 2) of the participant with the application system of this invention. In one embodiment this information may be obtained via a suitable API presented by the application system 120 on a participant client device. For example, a participant or other appropriate party may wish to remove a collateral asset so that it can be sold or refinanced free of encumbrances. First, the account status is updated, in operation step 505, to reflect removal of this asset, and if no collateral remains or if the value of the remaining collateral drops below a predetermined minimum threshold for secured accounts, the account is marked unsecured. Next, in operation step 507, the security interest is discharged and cancelled in the manner appropriate to the type of collateral. Note that in some embodiments, this may be performed electronically and, in some instances, may include the transmission of an image file of the appropriate signed document. As noted, discharge may by performed automatically (for example, by interaction with government computer systems), may require manual document handling and recordation, or may entail returning the asset to the participant. In operation step 509, evidence of discharge is forwarded to the participant. In operation step 511, information relating to this collateral is deleted from the system database 150. In operation step 513, removal processing terminates. Note that in an alternative embodiment, a decision operation step may be included to determine whether collateral asset removal will be permitted, or will be permitted only after one or more conditions are met. For example, if the participant is determined by the system to have a loan balance that exceeds a threshold amount based on a comparison operation, then the system may generate a communication to the participant that this collateral asset cannot be removed or can only be removed if a replacement asset is provided as collateral or if a portion of the loan is repaid.

The process by which collateral assets are added or updated is illustrated in FIG. 5B. In operation step 521, the processing to add or update a collateral asset commences by obtaining, in operation step 523, information regarding the asset to be added or regarding changes to collateral assets with existing security interests. In one embodiment this information may be obtained via a suitable API presented by the application system 120 on a participant client device. This information preferably includes or supplements those types of collateral information obtained for an initial collateral update as described above. For example, a participant may wish to add a collateral asset that has just been acquired or has been freed of prior encumbrances. A participant may also need to update the information used by the invention if refinancing has changed the character of a superior security interest, for example, by changing the amount secured. Further, reassessments or reappraisals of an existing collateral asset may also be submitted to the methods of this invention.

Depending on the nature of the added or updated information, add processing may branch to perform one of at least three actions. If an entirely new collateral asset is added, then, in operation step 525, a new security interest is established in this asset by performing the new security interest subroutine (subroutine 421 in FIG. 4). In certain cases, an existing security interest on a collateral asset in favor of an issuing financial entity of this invention must be modified in operation step 527. For example, if a participant has obtained new financing of the asset which by its terms requires a superior security interest, an existing interest of this invention may have to be modified to reflect the loss of superior status. The participant may also need to obtain approval from the issuing financial entity to modify the status.

Processing of security interest modifications to perfect a security interest, as shown in operation step 527, may have, in one embodiment, a structure equivalent to that for the already described new-security-interest subroutine described in FIG. 4 (and is thus not individually illustrated). Accordingly, if possible, a modification to perfect a collateral asset may be made automatically by, for example, electronic means. If an executed document is required, the necessary document is generated and forwarded for execution by the participant. When these modification steps are complete, any further steps necessary to perfect the interest are then completed. Lastly, in operation step 531, the account status is updated to “secured” (if not already so marked), and the new collateral information is stored in the system database,

Finally, update of collateral information may require no changes of an existing security interest, as shown in operation step 529, especially if the update is only to information used for interest rate determination. For example, a new estimated collateral asset value resulting from a new assessment or appraisal may not affect the nature of an existing security interest but may result in a change of interest rate. Therefore, such updated information is simply recorded in operation step 531 in the system database 150 for later use in an interest-rate-update processing. Collateral update processing then terminates in operation step 533.

FIG. 5C illustrates interest-rate-update processing. This processing permits issuing financial entities that utilize the services of the systems and methods of the present invention to offer generally lower interest rates that flexibly reflect the current financial and asset position of a participant. This processing, in one embodiment, makes use of the observation that a participant is less likely to default on credit repayment obligations if a security interest in a real property asset of the participant has been granted. Further, the more significant the asset, the less likely is default. Since the risk of default is less, that component of the interest rate reflecting risk of loan loss may be correspondingly reduced without burden to an issuing financial institution.

In more detail, interest rate determination for one embodiment is described with reference to the following simple model.
Account interest rate=cost of funds+expenses and profit+default/loss risk.

According to this model, an interest rate is set to be the sum of three major components. The first is the cost of funds to the credit-granting issuing financial entity, which is usually close to the current prime lending rate and is independent of the issuing financial entity and the participant. Next is an addition set by the issuing financial entity reflecting internal costs and expected profit. The final component is an addition reflecting the chances of default or loss which may be controlled to some extent by the participant. In addition to varying with a participant's general credit worthiness, this risk adjustment also varies with, for example, the collateral assets made available by the participant to secure the credit account. It depends on, for example, the importance of the collateral assets to the participant, their unencumbered values, the difficulties and costs of foreclosing on the assets, and the like. The interest rate may also be adjusted based on the timeliness of payments or other factors.

Turning to the details of FIG. 5C, collateral status updates resulting from initial collateral update operations, as shown in operation step 541 and from collateral add/remove processing operations, as shown in operation step 543, initiate interest rate processing in operation step 545 (or is called as a subroutine). For processing efficiency, the credit account or loan arrangement is first tested in operation step 547 for the presence of any collateral (indicated by a “secured” status). If the participant has offered no collateral, then the default/loss risk rate may be immediately assigned a value for unsecured accounts, or a default value may be selected according to rules based on one or more criteria. Then the process ends at step 559.

If the account has collateral in which the issuing financial institution has perfected at least one real property or other property security interest, the account default/loss risk is evaluated in operation step 551 by a risk model 555 based on one or more of several factors that may include: account collateral information, account LOC amount, the participant's net income available for repayment, and the participant's recent credit history including the current account's repayment history. Model input data is preferably stored on and is available from system database 553. In operation step 557, the default/loss risk is then used to update the interest rate. Interest rate processing terminates in operation step 559.

The risk model 555 in some embodiments automatically relates input data to estimated risk, and may be constructed using statistical analyses, or expert systems, or neural networks, or the like. However constructed, the model preferably reflects past default/loss experiences of the issuing financial entity (or of the industry). For example, the default/loss risk for an unsecured account may be set to an observed value of, for example, 12%. The risk model may determine that the default/loss risk for an account secured by a participant's residence in which there is sufficient equity to cover the entire LOC amount is approximately, for example, 2%. For a collateral asset of intermediate importance and value, such as a typical car, truck, or boat, the model may determine the default/loss risk to be an intermediate value, for example, 7%.

In this manner, the systems and methods of the present invention can afford a participant substantial control over the interest rate charged on credit accounts or loan arrangements. Further, a participant is not locked into a particular security arrangement because, subject to increased interest expenses, collateral assets may always be removed from an account.

In an alternate embodiment of the invention, the collateral assets associated with a credit granting account are categorized by classification. That is, the assets can be organized by asset type, such as: real estate and non real estate (personal property). The assets can also be organized by perfection status, such as perfected and non-perfected. For each asset, an appraised value can also be included. The assets in each class may be added to obtain a total asset value in each class. These classifications and values can be used to determine a new interest rate to be applied to outstanding balances on the credit granting account.

Loan Servicing/Default Processing

Loan servicing processing (120D in FIG. 2) is generally performed by the issuing financial entity. (Thus, this processing is therefore not illustrated.) It need not be altered by the invention, except for a need to accommodate interest rate changes. In some embodiments, the issuing financial entity may also be the entity practicing the methods and implementing the systems of this invention.

Generally, loan servicing includes normal processing as well as the handling of extraordinary events. Normal loan servicing includes, for example, authorizing payment vehicle use, clearing funds transfers, maintaining participant accounts, issuing statements, receiving repayments, and other operations. This may be processed in some embodiment in the normal manners for the payment vehicles used. The system database 150 of the present invention may advantageously be updated with selected credit history information of an account or of a participant that may be useful in, at least, later interest rate determinations.

Extraordinary events include participant non-performance of loan or credit obligations (for example, non-payment of interest), and incurable default. Such extraordinary events are also advantageously stored as part of the credit history stored in the system database. More importantly, in cases of default, the methods and systems of this invention may participate in foreclosing on security interests in account collateral, at least by making available, by electronic or other communication, collateral information, especially including the documents or other evidence of perfected security interests.

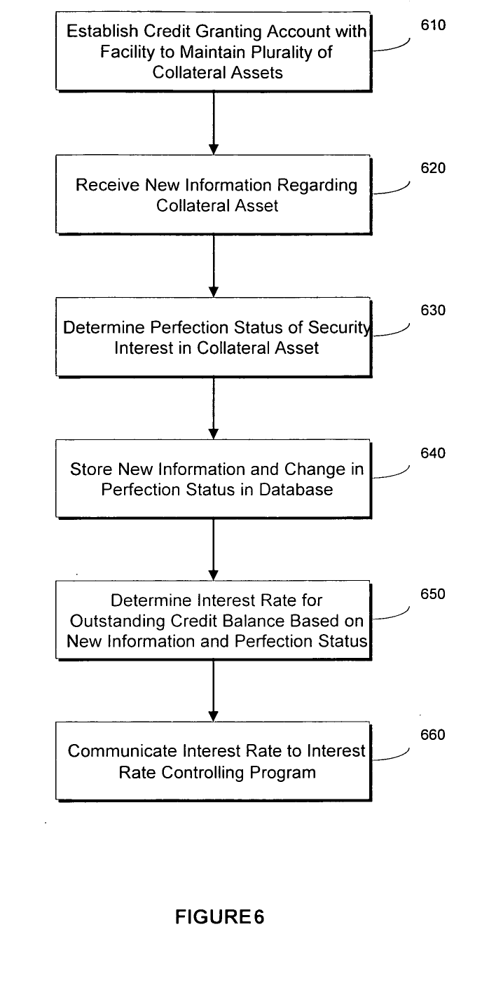

FIG. 6 illustrates a method in accordance with an exemplary embodiment of the invention. Operation step 610 illustrates the establishment of a credit granting account with a facility to maintain one or a plurality of collateral assets as collateral for the credit-granting account. In one embodiment, this is performed through an API. Operation step 620 illustrates receipt electronically or manually of new information regarding a collateral asset for securing the credit-granting account. This may be received directly from the participant, but can be received from other parties or systems. Operation step 630 illustrates the determination of a perfection status of a security interest in the collateral asset and may be performed electronically by accessing external or internal electronic databases or otherwise, and/or may encompass a document review to determine if an asset is listed as a perfected collateral asset in the new information. Operation step 640 illustrates the storage, in electronic database 150 of new information regarding the collateral asset and changes in its perfection status. Such a database 150 includes information describing collateral assets of the participant used for securing the credit-granting account. Operation step 650 illustrates the determination of an interest rate to be charged on outstanding credit balances based on new information regarding the collateral asset available for securing the credit-granting account, including the perfection status of the collateral asset. Operation step 660 illustrates the communication of the interest rate to an interest rate controlling program that controls the interest rate charged on the credit-granting account.

The potential tax advantages associated with interest payments on home equity financing are important to the participant and to the lender. In an alternate embodiment of the invention, the application system 120 will automatically generate and send to the participant by mail or via the line 102 to a designated participant client a report describing tax implications of interest paid or to be paid for the credit-granting account during the time that the account is secured by residential real estate or other assets if permitted by law. Such a report can be generated periodically, for example, to correspond to the timing of tax return preparation. In one embodiment, such a report can be generated and sent electronically or otherwise to the participant in advance of or as a part of the collateral updating process 120B. In other embodiments, the application system 120 may present an API to a participant to allow the participant to make queries or send a notice by mail. For example, the participant may send an electronic query from a participant client to the application system 120 via an appropriate API provided by the application system 120 to determine the amount of a tax deduction if a selected asset is added in the future as collateral for the credit-granting account, or may send this query by mail. The application system 120 would then compute the desired tax deduction information and send that information to the participant's client or by mail or by other appropriate means. In another alternate embodiment of the invention, such tax information is generated and sent to the participant by a third party service provider, such as a tax advisory service that has been provided electronically or otherwise with appropriate data on the interest paid or to be paid, the time period during which the credit-granting account was secured by an asset that triggers tax deductibility under the law, such as a participant residence, and any other necessary data. This third party may also be requested to facilitate electronic transmission of such tax information to the tax return preparer software being used by or on behalf of the participant. In alternative embodiments, the above implementations may be carried out for non-real estate assets, where the tax laws permit such deductibility.

In further alternative embodiments when the participant is a corporation or other legal person, then the application system 120 will automatically generate and send to the participant by mail or via the line 102 to the designated participant client a report describing tax implications of interest paid or to be paid for the credit-granting account for purposes of a business deduction or credit. Such a report can be generated periodically, for example, to correspond to the timing of tax return preparation. In one embodiment, such a report can be generated and sent electronically or otherwise to the participant based on some convenient event set by the company. In other embodiments, the application system 120 may present an API to a participant company to allow the participant company to make queries or send a notice by mail. For example, the participant may send an electronic query from a participant client to the application system 120 via an appropriate API provided by the application system 120 to determine the amount of a tax deduction or credit, or may send this query by mail. The application system 120 would then compute the desired tax deduction information and send that information to the participant's client or by mail or by other appropriate means. In another alternate embodiment of the invention, such tax information is generated and sent to the participant company by a third party service provider, such as a tax advisory service that has been provided electronically or otherwise with appropriate data on the interest paid or to be paid, and any other necessary data for obtaining the business deduction or credit. This third party may also be requested to facilitate electronic transmission of such tax information to the tax return preparer software being used by or on behalf of the participant company.

Accordingly, an advantage of one embodiment of the present invention is to provide a system and method that offers to consumers equity-backed financing accessible by means of a wide variety of payment vehicles (check, credit card, debit card, wire transfer, ACH, sweeps, etc.) for convenient, easy, daily transactions.

An advantage of another embodiment of the present invention is to permit consumers to add or remove collateral assets for their accounts, and to adjust a current interest rate for each account in dependence on the value of secured assets available to that account.

An advantage of another embodiment of the present invention is to provide a data processing system for assessing and tracking daily transactions of a credit account secured by consumer collateral assets, especially by home equity.

An advantage of another embodiment of the present invention is to provide a data processing system for managing a plurality of equity backed accounts, each account individually associated with a separate consumer financing plan.

An advantage of another embodiment of the present invention is to provide a data processing method for establishing a line of credit (LOC) amount for a plurality of separate accounts and tracking account events including account status (secured/unsecured), consumer purchasers and the like.

An advantage of another embodiment of the present invention is to provide a data processing method of establishing a plurality of finance charge algorithms related to the establishment of a secured or unsecured line of credit for a plurality of separate accounts.

Selected embodiments of the systems and methods of the present invention permit more streamlined, and/or convenient, and/or cost effective secured consumer financing, especially financing secured by consumer home equity. Consumers will benefit in some embodiments by receiving financing with lower interest rates. Lenders will benefit in some embodiments from reduced default rates on such loans and from the consequent lower administrative and default costs. Thus, by means of this invention, consumers will now be afforded in some embodiments low cost, easily obtainable financing.

One embodiment of the present invention comprises a data processing system that executes programmed methods which monitor a plurality of credit or loan accounts, each account limited by a consumer's approved line of credit (LOC) amount and secured by a perfected security interest, such as a recorded mortgage, that is placed on consumer assets, such as their home, made available as collateral. Collateral assets available as security may be changed from time-to-time. Optionally, the account may not be secured by any collateral. Therefore, a participant (for example, a cardholder where credit card access is provided) may move easily between a secured and an unsecured status within the same loan arrangement (for example, without changing credit card accounts).

The LOC amount may be established according to known credit criteria established and used by issuing financial institutions (banks, credit unions, etc.) that implement the present invention. Consumer credit histories may be accessed from a local or remote database as part of a credit-granting decision. The LOC amounts in some embodiments, are not based only on the consumer's equity value, but may include the consumer's ability to repay. The LOC may be made available by means of a wide variety of payment vehicles (check, credit card, debit card, wire transfer, ACH, sweeps, etc.). Transactions made by the participants may be tracked and stored. In some embodiments of the invention, outstanding loan or credit balances are thereafter charged an incremental interest rate based on an account's secured/unsecured status and adjusted by the system based on events (for example, a home sale or a home refinancing) that affect the collateral. Such events are periodically or stochastically captured and processed by the system. LOC amount adjustments are made based on ensuing events as needed.

In some embodiments of the present invention, the interest charged for the outstanding balances may be adjusted according to an account's secured status, which is evidenced by one or more security documents (such as mortgages, notes, etc). Where the collateral is a consumer's home equity, an account will enjoy potentially tax-deductible transactional financing. In some embodiments, the system also enables the consumer, using the same payment vehicle, to access both a secured finance arrangement and an unsecured finance arrangement. Accordingly, the system further comprises programming to adjust the secured/unsecured feature based on events initiated by the cardholder.

Another advantage of some embodiments of the present invention is the creation of a novel financial product, combining the tax advantages of equity backed credit and the user privileges and ease of access to funds of traditional credit cards. Numerous other advantages in comparison to current financing arrangements will be apparent to one of ordinary skill in the art.

It should be noted that although the flow charts provided herein show a specific order of method steps, it is understood that the order of these steps may differ from what is depicted. Also two or more steps may be performed concurrently or with partial concurrence. Such variation will depend on the software and hardware systems chosen and on designer choice. It is understood that all such variations are within the scope of the invention. Likewise, software and web implementations of the present invention could be accomplished with programming techniques with rule based logic and other logic to accomplish the various database searching steps, correlation steps, comparison steps and decision steps. It should also be noted that the word “component” as used herein and in the claims is intended to encompass implementations using one or more lines of software code, and/or hardware implementations, and/or equipment for receiving manual inputs.

The foregoing description of embodiments of the present invention has been presented for purposes of illustration and description. It is not intended to be exhaustive or to limit the present invention to the precise form disclosed, and modifications and variations are possible in light of the above teachings or may be acquired from practice of the present invention. The embodiments were chosen and described in order to explain the principals of the present invention and its practical application to enable one skilled in the art to utilize the present invention in various embodiments and with various modifications as are suited to the particular use contemplated.

Note that aspects of the claims may be performed by different entities that operate in cooperation in accordance with a written contract or other agreement to perform the claimed operation.

What is claimed is:

1. A data processing system for managing at least one credit-granting account of a participant, said system comprising:
an electronic database including information describing collateral assets of the participant used for securing the credit-granting account, and
a computer system comprising one or more processors coupled to the electronic database and programmed among them to
(i) establish through an API a credit-granting account with a facility to maintain a plurality of collateral assets as collateral for the credit-granting account;
(ii) receive new information regarding a collateral asset that is real estate for securing the credit-granting account;
(iii) determine perfection status of a security interest in the collateral asset;
(iv) store, in the electronic database, the new information and at least any change in the perfection status;
(v) determine an interest rate to be charged on outstanding credit balances based on the new information regarding the collateral asset available for securing the credit-granting account containing the perfection status; and
an electronic network access device for sending a signal identifying the new interest rate to an access-vehicle issuing system so that the issuing system can charge the interest rate on outstanding credit balances.

2. The system as defined in claim 1 wherein the received information indicates addition of a new collateral asset available for securing the account, and wherein the new interest rate is determined to be not greater than a prior interest rate.

3. The system as defined in claim 2 further comprising sending a signal to establish a security interest in the new collateral asset to the benefit of the credit-granting account.

4. The system as defined in claim 1 wherein the received information indicates removal of a collateral asset not being used to secure the account, and wherein the determined interest rate is not less than a prior interest rate.

5. The system as defined in claim 1, further comprising the computer system programmed for receiving new information about a collateral asset of the participant that is not real estate, and wherein the computer system is programmed to perform the determining perfection status step, the storing the new information step, the determining an interest rate step, and the sending a signal identifying the new interest rate step with respect to this collateral asset that is not real estate.

6. The system as defined in claim 1, further comprising the computer system programmed for sending a signal to initiate establishing a security interest in the collateral asset to the benefit of the credit-granting account.

7. The system as defined in claim 1, further comprising the computer system programmed for automatically accessing at least one external asset perfection electronic database to determine the perfection status for at least one of the collateral assets for the credit-granting account.

8. The system as defined in claim 7, further comprising the computer system programmed for sending an alert signal if there is a discrepancy between the perfection status in the electronic database and information in the external asset perfection electronic database.

9. The system as defined in claim 1, further comprising the computer system programmed for automatically accessing a plurality of external electronic databases, one for each of a plurality of the collateral assets wherein said accessing is performed based upon predetermined criteria.

10. The system as defined in claim 1, further comprising the computer system programmed for making a display of information for the credit-granting account available on a network accessible by at least one external party.

11. The system as defined in claim 1, further comprising the computer system programmed for making a display of an image of a security interest document for at least one collateral asset for the credit-granting account available on a network accessible by at least one external party.

12. The system as defined in claim 1, the computer system programmed for changing an available line of credit to the participant in the credit-granting account based on the new information.

13. The program product as defined in claim 9, wherein the new information comprises a change in the perfection status of a collateral asset.

14. The system as defined in claim 1, further comprising the computer system programmed for preparing information regarding tax implications of interest paid while the credit-granting account is secured by a residence; and sending a signal with that information to the participant or a third party.

15. The system as defined in claim I, further comprising the computer system programmed for sending a signal identifying interest information to a third party for preparation of a report relating to the participant regarding tax implications of interest paid while the credit-granting account is secured by a residence.

16. The system as defined in claim 15, wherein the computer system is programmed to send a request to said third party to facilitate electronic transfer of tax information relating to the participant to one or more computers for use by tax return preparation software.

17. The system as defined in claim 1, further comprising the computer system programmed to
present an API accessible via a network to receive a query regarding tax deduction information if an asset may be or has been provided as a collateral asset for securing the credit-granting account; and
send that tax deduction information to a participant or a third party client.

18. The system as defined in claim 1, wherein the computer system is programmed to send a signal to initiate a credit verification step if a predetermined criterion is met.

19. The system as defined in claim 18, wherein the predetermined criterion is chosen from the group consisting of the LOC rising above a threshold amount and the credit score of the applicant dropping below a threshold amount, and wherein the computer system is programmed to initiate review of perfection databases for one or more of the collateral assets listed for the credit-granting account if the predetermined criterion is met.

20. A program product for managing at least one credit-granting account of a participant, comprising
a set of computer readable media having machine-readable program code embodied among them, that when executed by one or more machines, are capable of performing the following method steps, where set is one or more:
establishing through an API a credit-granting account with a facility to reference one or more collateral assets as collateral for the credit-granting account;
receiving new information regarding a collateral asset that is real estate for securing the credit-granting account;
determining a perfection status of a security interest in the collateral asset;
storing the new information in the electronic database and at least any change in the perfection status;
determining an interest rate to be charged on outstanding credit balances based on the new information regarding the collateral asset available for securing the credit-granting account containing the perfection status; and
sending a signal identifying the interest rate to an access-vehicle issuing system so that the issuing system can now charge the interest rate.

21. The program product as defined in claim 20, wherein the real estate is a residence of the participant.

22. The program product as defined in claim 20, further comprising program code for receiving new information about a collateral asset that is intangible property of the participant, and performing the determining perfection status step, the storing the new information step, the determining an interest rate step, and the sending the signal identifying the new interest rate step with respect to this collateral asset that is intangible property.

23. The program product as defined in claim 20, further comprising program code for receiving new information about a collateral asset of the participant that is not real estate, and performing the determining perfection status step, the storing the new information step, the determining an interest rate step, and the sending a signal identifying the new interest rate step with respect to this collateral asset that is not real estate.

24. The program product as defined in claim 20 wherein the received information indicates addition of a new collateral asset available for securing the account, and wherein the new interest rate is determined to be not greater than a prior interest rate.

25. The program product as defined in claim 24 further comprising program code for sending a signal initiating establishing a security interest in the new collateral asset to the benefit of the credit-granting account.

26. The program product as defined in claim 20 wherein the received information indicates removal of a collateral asset not being used to secure the account, and wherein the determined interest rate is not less than a prior interest rate.

27. The program product as defined in claim 20, further comprising program code for sending a signal to initiate establishing a security interest in the collateral asset to the benefit of the credit-granting account.

28. The program product as defined in claim 20, further comprising program code for automatically accessing at least one external asset perfection electronic database to determine the perfection status for at least one of the collateral assets for the credit-granting account.

29. The program product as defined in claim 28, further comprising sending an alert signal if there is a discrepancy between the perfection status in the electronic database and information in the external asset perfection electronic database.

30. The program product as defined in claim 20, further comprising program code for automatically accessing a plurality of external electronic databases, one for each of a plurality of the collateral assets wherein said accessing is performed based upon predetermined criteria.

31. The program product as defined in claim 29, wherein said accessing is performed substantially periodically.

32. The program product as defined in claim 20, further comprising program code for making a display of information for the credit-granting account available on a network accessible by at least one external party.

33. The program product as defined in claim 20, further comprising program code for making a display of an image of a security interest document for at least one collateral asset for the credit-granting account available on a network accessible by at least one external party.

34. The program product as defined in claim 20, further comprising program code for determining a class of each collateral asset listed for the credit-granting account; and for adding a value of collateral assets in each class.

35. The program product as defined in claim 34, wherein classes include perfected and not perfected.

36. The program product as defined in claim 34, wherein the classes include real estate and non-real estate.

37. The program product as defined in claim 20, changing an available line of credit to the participant in the credit-granting account based on the new information.

38. The program product as defined in claim 20, wherein the new information comprises a change in the perfection status of a collateral asset.

39. The program product as defined in claim 20, further comprising program code for automatically providing information in response to an external query.

40. The program product as defined in claim 39, wherein the external query is by telephone.

41. The program product as defined in claim 39, further comprising an API for receiving the external query, and wherein the external query is by computer.

42. The program product as defined in claim 20, further comprising program code for preparing information regarding tax implications of interest paid while the credit-granting account is secured by a residence; and sending a signal with that information to the participant or a third party.

43. The program product as defined in claim 20, further comprising program code for automatically sending a signal identifying interest information to a third party for preparation of a report for the participant regarding tax implications of interest paid while the credit-granting account is secured by a residence.

44. The program product as defined in claim 20 further comprising program code for sending a request to said third party to facilitate electronic transfer of tax information relating to the participant to one or more computers for use by tax return preparation software.

45. The program product as defined in claim 20, further comprising the program code to
present an API accessible via a network to receive a query regarding tax deduction information if an asset may be or has been provided as a collateral asset for securing the credit-granting account; and
send that tax deduction information to a participant or a third party client.

46. The program product as defined in claim 20, further comprising program code to send a signal to initiate a credit verification step if a predetermined criterion is met.

47. The program product as defined in claim 46, wherein the predetermined criterion is chosen from the group consisting of the LOC rising above a threshold amount and the credit score of the applicant dropping below a threshold amount, and further comprising program code to initiate review of perfection databases for one or more of the collateral assets listed for the credit-granting account if the predetermined criterion is met.

48. A method for managing at least one credit-granting account of a participant, said method comprising:
establishing through an API a credit-granting account with a facility to at least one collateral asset as collateral for the credit-granting account;
receiving new information regarding a collateral asset that is real estate for securing the credit-granting account;
determining a perfection status of a security interest in the collateral asset;
storing, in a electronic database, the new information and at least any change in the perfection status;
determining electronically an interest rate to be charged on outstanding credit balances based on the new information regarding the collateral asset available for securing the credit-granting account containing the perfection status; and
sending a signal identifying the interest rate to an interest rate program that controls the interest rate for the credit-granting account.

49. A method for managing at least one credit-granting account of a participant, said method comprising:
receiving information from the participant regarding a real estate collateral asset for securing the credit-granting account,
storing, in an electronic database, the received information,
determining electronically a new interest rate to be charged on outstanding account credit balances based on information regarding the collateral assets available for securing the credit-granting account, and
sending a signal identifying the interest rate to an interest rate program that controls the interest rate for the credit-granting account.

50. The method as defined in claim 49 further comprising updating an electronic database storing the collateral asset information with the received information.

51. The method as defined in claim 49 wherein the collateral asset information comprises information concerning real property of the participant.

52. The method as defined in claim 51 wherein the real property includes a residence of the participant.

53. The method as defined in claim 51 further comprising receiving information from the participant regarding personal property as a collateral asset for securing the credit-granting account; and performing the determining perfection status step, the storing the new information step, the determining an interest rate step, and the sending a signal identifying the new interest rate step with respect to this collateral asset that is personal property.

54. The method as defined in claim 49 further comprising receiving information from the participant regarding intangible property of the participant as a collateral asset for securing the credit-granting account, and performing the determining perfection status step, the storing the new information step, the determining an interest rate step, and the sending a signal identifying the new interest rate step with respect to this collateral asset that is intangible property.

55. The method as defined in claim 49 wherein stored information for a collateral asset comprises an identification of the asset, an estimate of the asset's value, and an indication of the presence or absence of a security interest in the asset benefiting the credit-granting account.

56. The method as defined in claim 49 wherein the received information indicates addition of a new collateral asset available for securing the account, and wherein the new interest rate is determined to be not greater than a prior interest rate.

57. The method as defined in claim 56 wherein, if prior to addition of the indicated collateral asset, the credit-granting account was secured by no collateral assets, the new interest rate is determined to be less than a prior interest rate.

58. The method as defined in claim 56 further comprising establishing a security interest in the new collateral asset to the benefit of the credit-granting account.

59. The method as defined in claim 55 wherein the received information indicates removal of a collateral asset not being used to secure the account, and wherein the determined interest rate is not less than a prior interest rate.

60. The method as defined in claim 59 wherein, after removal of the indicated collateral asset, the credit-granting account is secured by no collateral assets, and wherein the new interest rate is determined as for a similar unsecured account.

61. The method as defined in claim 49 wherein the received information indicates a change in financing arrangements for a collateral asset used for securing the account.

62. The method as defined in claim 55 wherein the interest rate is determined based on at least the risk of default or loss observed for other credit-granting accounts secured with similar security interests.

63. The method as defined in claim 62 wherein the interest rate is determined based further in dependence on prior credit information concerning the participant.

64. The method as defined in claim 49 further comprising:
receiving application information from a participant, and approving or disapproving the credit-granting account for the participant based on the received information.

65. The method as defined in claim 64 wherein the approving or disapproving is independent from collateral assets that the participant proposes to secure the account.

66. The method as defined in claim 49, further comprising preparing information regarding tax implications of interest paid while the credit-granting account is secured by a residence; and
sending a signal with that information to the participant or a third party.

67. The method as defined in claim 49, further comprising sending a signal identifying interest information to a third party for preparation of a report for the participant regarding tax implications of interest paid while the credit-granting account is secured by a residence.

68. The method as defined in claim 55 wherein said third party is requested to facilitate electronic transfer of tax information relating to the participant to one or more computers for use by tax return preparation software.

69. The method as defined in claim 49, further comprising
receiving a query regarding tax deduction information if an asset may be or has been provided as a collateral asset for securing the credit-granting account; and
sending that tax deduction information to a participant or a third party client.

70. The method as defined in claim 49, further comprising initiating a credit verification step if a predetermined criterion is met.

71. The method as defined in claim 64, wherein the predetermined criterion is chosen from the group consisting of the LOC rising above a threshold amount and the credit score of the applicant dropping below a threshold amount, and wherein the credit verification step comprises initiating review of perfection databases for one or more of the collateral assets listed for the credit-granting account if the predetermined criterion is met.

72. A data processing system for managing at least one credit-granting account of an participant, said system comprising:
an electronic database containing information describing collateral assets used for securing the credit-granting account, and
a computer system comprising one or more processors coupled to the electronic database and programmed to
(i) receive information from the participant regarding a real estate collateral asset for securing the credit-granting account,
(ii) store, in the electronic database, the received information,
(iii) determine a new interest rate to be charged on outstanding credit balances based on information regarding the collateral assets available for securing the credit-granting account, and
(iv) sending a signal identifying the interest rate to an interest rate program that controls the interest rate for the credit-granting account.

73. The system as defined in claim 72 further comprising a communications interface to an access-vehicle issuing system, the participant accessing the credit-granting account by means of an issued access vehicle.

74. The system as defined in claim 64 wherein an issued access vehicle includes at least a check, or a credit card, or a debit card, or a wire transfer, or an ACH transfer, or a sweep transfer.

75. The system as defined in claim 72 wherein the new interest rate is determined to increase if the value of the collateral assets available to secure the credit-granting account decreases, and is determined to decrease if the value of those assets increases.

76. The system as defined in claim 72 wherein the computer system is further programmed to determine a line of credit (LOC) amount from prior credit information of the participant.

77. The system as defined in claim 72 wherein the computer system is further programmed to update an available LOC based on an outstanding credit balance of the participant determined from information received from an access-vehicle issuing system.

78. The system as defined in claim 72 wherein the processor is further programmed to
(i) receive application information from a participant, and
(ii) approve or disapprove the credit-granting account for the participant based on the received application information.

79. The system as defined in claim 69 wherein, upon approval, the processor is further programmed to cause an access-vehicle issuing system to issue an access vehicle to the participant.

80. The system as defined in claim 72 wherein the received information comprises an indication of the addition or removal of real property of the participant as a collateral asset for securing the credit-granting account.

81. The system as defined in claim 72 wherein the real property comprises a residence of the participant.

82. The system as defined in claim 72 where the new interest rate is determined to be less than a prior interest rate if real property collateral is added and is determined to be greater than a prior interest rate if real property collateral is removed.

83. The system as defined in claim 72, further comprising the computer system programmed for sending a signal to initiate establishing a security interest in the collateral asset to the benefit of the credit-granting account.

84. The system as defined in claim 72, further comprising the computer system programmed for automatically accessing at least one external asset perfection electronic database to determine the perfection status for at least one of the collateral assets for the credit-granting account.

85. The system as defined in claim 84, further comprising the computer system programmed for sending an alert signal if there is a discrepancy between the perfection status in the electronic database and information in the external asset perfection electronic database.

86. The system as defined in claim 72, further comprising the computer system programmed for automatically accessing a plurality of external electronic databases, one for each of a plurality of the collateral assets wherein said accessing is performed based upon predetermined criteria.

87. The system as defined in claim 72, further comprising the computer system programmed for making a display of information for the credit-granting account available on a network accessible by at least one external party.

88. The system as defined in claim 72, further comprising the computer system programmed for making a display of an image of a security interest document for at least one collateral asset for the credit-granting account available on a network accessible by at least one external party.

89. A program product for managing at least one credit-granting account of a participant, comprising
a set of computer readable media having machine-readable program code embodied among them, that when executed by one or more machines, are capable of performing the following method steps, where set is one or more:
(i) receiving information from the participant regarding a real estate collateral asset for securing the credit-granting account,
(ii) storing in an electronic database, the received information,
(iii) determine a new interest rate to be charged on outstanding credit balances based on information regarding the collateral assets available for securing the credit-granting account, and
(iv) sending a signal identifying the interest rate to an interest rate program that controls the interest rate for the credit-granting account.

90. The program product as defined in claim 89, further comprising computer code for sending a signal to initiate establishing a security interest in the collateral asset to the benefit of the credit-granting account.

91. The program product as defined in claim 89, further comprising program code for accessing at least one external asset perfection electronic database to determine the perfection status for at least one of the collateral assets for the credit-granting account.

92. The program product as defined in claim 91, further comprising program code for sending an alert signal if there is a discrepancy between the perfection status in the electronic database and information in the external asset perfection electronic database.

93. The program product as defined in claim 91, wherein said accessing at least one external asset perfection electronic database is performed if said received new information contains any change to the credit-granting account.

94. The program product as defined in claim 89, further comprising program code for automatically accessing a plurality of external electronic databases, one for each of a plurality of the collateral assets wherein said accessing is performed based upon predetermined criteria.

95. The program product as defined in claim 89, further comprising program code for making a display of information for the credit-granting account available on a network accessible by at least one external party.

96. The program product as defined in claim 89, further comprising program code for making a display of an image of a security interest document for at least one collateral asset for the credit-granting account available on a network accessible by at least one external party.

97. The program product as defined in claim 89, further comprising program code for initiating an additional credit verification related step if a predetermined criterion is met.

98. The system as defined in claim 1, further comprising the computer system programmed for preparing information regarding tax implications for a business on interest paid for the credit-granting account; and sending a signal with that information to the participant or a third party.

99. The system as defined in claim 1, further comprising the computer system programmed for sending a signal identifying interest information to a third party for preparation of a report regarding tax implications for a business of interest paid for the credit-granting account.

100. The program product as defined in claim 20, further comprising program code for preparing information regarding tax implications for a business of interest paid for the credit-granting account; and sending a signal with that information to the participant or a third party.

101. The program product as defined in claim 20, further comprising program code for automatically sending a signal identifying interest information to a third party for preparation of a report regarding tax implications for a business of interest paid for the credit-granting account.

102. The method as defined in claim 49, further comprising preparing information regarding tax implications for a business on interest paid for the credit-granting account; and
sending a signal with that information to the participant or a third party.

103. The method as defined in claim 49, further comprising sending a signal identifying interest information to a third party for preparation of a report for the participant regarding tax implications for a business of interest paid for the credit-granting account.

104. The data processing system as defined in claim 72, further comprising the computer system programmed for preparing information regarding tax implications for a business on interest paid for the credit-granting account; and sending a signal with that information to the participant or a third party.

105. The data processing system as defined in claim 72, further comprising the computer system programmed for sending a signal identifying interest information to a third party for preparation of a report regarding tax implications for a business of interest paid for the credit-granting account.

106. The program product as defined in claim 89, further comprising program code for preparing information regarding tax implications for a business of interest paid for the credit-granting account; and sending a signal with that information to the participant or a third party.

107. The program product as defined in claim 89, further comprising program code for automatically sending a signal identifying interest information to a third party for preparation of a report regarding tax implications for a business of interest paid for the credit-granting account.
